(19) United States
(12) Patent Application Publication
(10) Pub. No.: US 2006/0108452 A1
(43) Pub. Date: May 25, 2006

(54) Valve for injecting fuel

(76) Inventors: Claus Anzinger, Neutraubling (DE); Luca Gestri, S. Lorenzo alle Corti (PI) (IT); Luca Matteucci, Pisa (IT); Willibald Schurz, Pielenhofen (DE); Martin Simmet, Bad Abbach (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/265,910

(22) Filed: Nov. 3, 2005

(30) Foreign Application Priority Data
Nov. 4, 2004 (DE) 10 2004 053 352.0

(51) Int. Cl. F02M 61/08

(52) U.S. Cl. 239/533.7; 239/453

(57) ABSTRACT

A valve for injecting fuel has a valve body (4), in which a recess is embodied. The recess widens in a downstream side region (11) to a separation edge. The valve further comprises a valve needle which is arranged in the recess and has a closing element (14). In a closed position the closing element (14) seats on a valve seat (18) and blocks or else releases the flow. The closing element (14) is embodied such that a gap (19) is embodied between the valve body (4) and the closing element (14) downstream of the valve body (4), the gap comprising a gap angle (β), a gap length (l) and a maximum gap width (s). The gap angle (β) and the gap length (1) are embodied such that in the closed position, the maximum gap width (s) is at least as large as a surface roughness of the valve body (4) or of the closing element (14) and that the maximum gap width (s) amounts to a maximum of 10 micrometers.

### CROSS-REFERENCE TO RELATED APPLICATIONS

This application claims priority from German Patent Application No. 10 2004 053 352.0, which was filed on Nov. 4, 2004, and is incorporated herein by reference in its entirety.

### TECHNICAL FIELD

The invention relates to a valve for injecting fuel, having a valve body, in which a recess is embodied and a valve needle which is arranged so that it can move axially in said recess. The valve needle comprises a closing element, which widens in a flow direction of a fuel flow into a conical or spherical shape.

### SUMMARY

The object underlying the invention is to create a valve, in which a spray image of the injected fuel is permanently protected against deposit-specific changes.

The object can be achieved by A valve for injecting fuel comprising a valve body in which a recess is embodied, the recess extending into a downstream side region in a flow direction of the fuel in a conical or spherical manner to a separation edge and wherein a wall of the recess in the downstream side region forms a valve seat, and a valve needle, which is arranged so that it can move axially in the recess, and which has a closing element on a downstream side end region, which widens in the flow direction to a first edge in a conical or spherical shape and in a closed position, the closing element seats on the valve seat and blocks or else releases a fuel flow, wherein the separation edge has a first distance to the valve seat, the closing element being embodied such that a gap is embodied between the valve body and the closing element downstream of the valve seat, said gap having a gap angle and a maximum gap width, the gap angle and the first distance being embodied such that in the closed position the maximum gap width is at least as large as a surface roughness of the valve body or of the closing element, and the gap angle and the first distance being designed such that in the closed position, the maximum gap width amounts to a maximum of 10 micrometers.

In the closed position the maximum gap width may amount to a maximum of 5 micrometers. The first distance may amount to between 50 micrometers and 500 micrometers. The gap angle can amount to approximately between 1 degree and 10 degrees. The first edge may have a second distance to the valve seat and the first distance can be smaller than the second distance.

Thus, the invention is characterized by a valve for injecting fuel, having a valve body, in which a recess is embodied. In a downstream side region, the recess widens into a conical or spherical shape, in a flow direction of the fuel to a separation edge. A wall of the recess in the downstream side region forms a valve seat. The valve further comprises a valve needle, which is arranged so that it can move axially in the recess and which has a closing element at the downstream side end region, which widens into a conical or spherical shape in the flow direction to a first edge. The closing element seats in a closed position on the valve seat and blocks or else releases a fuel flow. The separation edge has a first distance to the valve seat. The closing element is embodied such that a gap is embodied between the valve body and the closing element downstream of the valve seat, said gap comprising a gap angle and a maximum gap width. The gap angle and the first distance are embodied such that, in the closed position, the maximum gap width is at least as large as a surface roughness of the valve body or the closing element. The gap angle and the first distance are further embodied such that, in the closed position, the maximum gap width amounts to a maximum of 10 micrometers.

The invention is based on the knowledge that deposits form during operation on areas of a valve which are exposed to hot combustion gases and over which the fuel flow does not pass at a high velocity. These deposits, which essentially consist of carbon, can form at high temperatures through coking of fuel residues in the gap or combustion residues from the combustion gases. These deposits can accumulate to such a degree that they extend as far as the fuel flow and thus deflect the fuel flow unintentionally from the predominantly upstream flow direction. These unintentional deposits accumulate for instance in a downstream region of the gap, in particular in a region of the first edge of the closing element. A spray image of the valve can thus be changed in a disadvantageous manner.

The design of the maximum gap width of less than 10 micrometers allows a volume of the gap to be small enough for only a minimum amount of fuel to remain in the gap in the closed position of the valve needle. The fuel remaining in the gap is then equally as effectively thermally coupled to the valve body and to the closing element of the valve needle, thereby preventing the fuel from being heated by hot combustion gases sufficiently for coking to take place and for unwanted deposits to form. As a result of the small dimensions of the gap, the accumulation of the unwanted deposits and deposits influencing the spray image can be reliably prevented.

In an advantageous embodiment of the invention, the maximum gap width in the closed position amounts to a maximum of 5 micrometers. This is advantageous in that the gap is designed to be particularly narrow and that the gap thus comprises a particularly small volume. This allows a particularly small amount of fuel to remain in the gap, the fuel being particularly well thermally coupled to the valve body or to the closing element and thereby reliably obviating the coking of the fuel.

In a further advantageous embodiment of the invention, the first distance amounts to between approximately 50 micrometers and 500 micrometers. The gap is thus so short that the volume of the gap can be very small. Furthermore, the valve with the gap designed downstream of the valve seat is more simple to manufacture with the desired spray image than a valve without a gap of this type.

In a further advantageous embodiment of the invention, the gap angle amounts to approximately between 1 degree and 10 degrees. The gap angle is thus large enough for a secure locking of the valve to be guaranteed in the closed position and is small enough for the volume of the gap to be very small.

In a further advantageous embodiment of the invention, the first edge has a second distance to the valve seat. The first distance is thus smaller than the second distance. A valve of this type allows a particularly stable spray image.

### BRIEF DESCRIPTION OF THE DRAWINGS

Exemplary embodiments of the invention are described below with reference to the schematic drawings, in which

FIG. 1 shows a valve,

FIG. 2 shows a downstream side region of the valve according to FIG. 1

FIG. 3 shows an enlarged section of the downstream side region of the valve according to FIG. 2, and

FIG. 4 shows an enlarged section of the downstream side region of the valve according to FIG. 3.

Elements of the same construction or function are provided with the same reference characters in all the figures.

### DETAILED DESCRIPTION

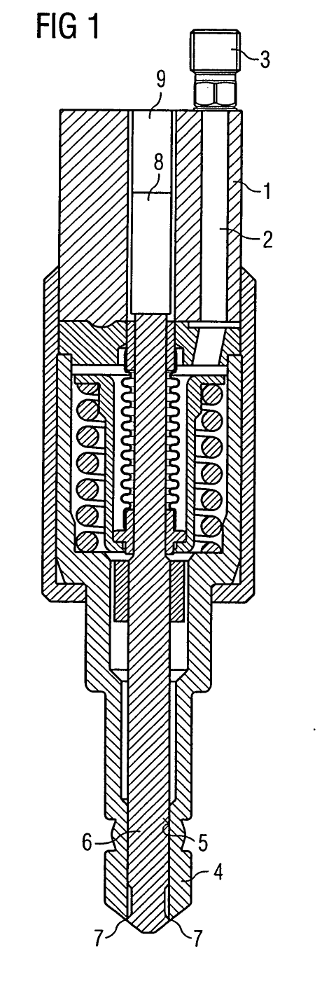

FIG. 1 shows a valve for injecting fuel, in particular for internal combustion engines in motor vehicles for injecting fuel. The valve has an injector housing 1, in which a hole 2 is embodied, and a connector 3, which is coupled to the hole 2, through which fuel can be fed to the valve. The valve further comprises a valve body 4 with a recess 5, in which a valve needle 6 is arranged in an axially moveable manner, which locks an injection nozzle 7 in a closed position or else allows a fuel flow through the injection nozzle 7. The valve further comprises a lifting device with an actuator 8 and a balancing element 9 which are coupled with one another in the axial direction. The actuator 8 is a piezoactuator for example. The lift of the lifting device is dependent on the axial expansion of the actuator 8, which is dependent on an actuator signal. The lifting device is coupled to the valve needle 6 and thus interacts together with the valve needle 6, such that the lift of the lifting device is transferred to the valve needle 6 and that the valve needle 6 is thus moved into its closed position or into an open position.

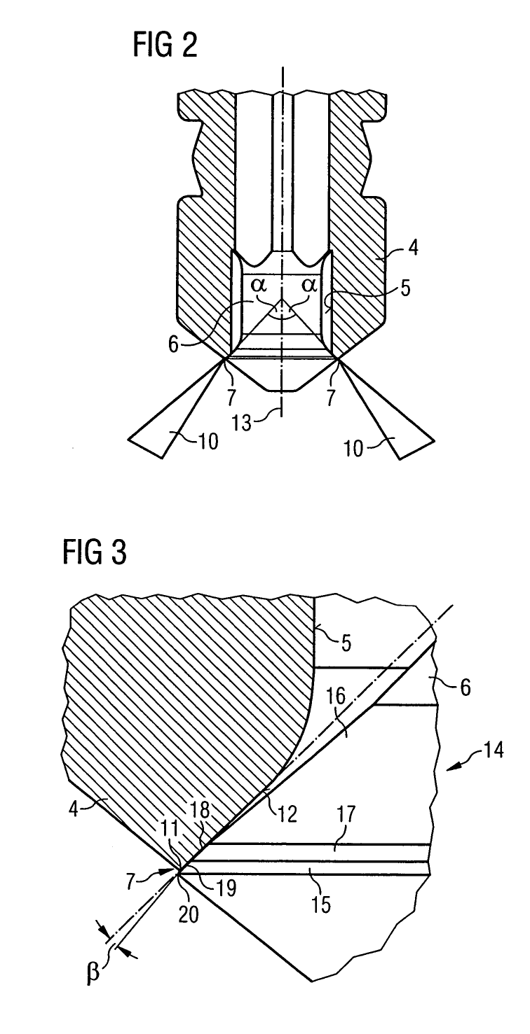

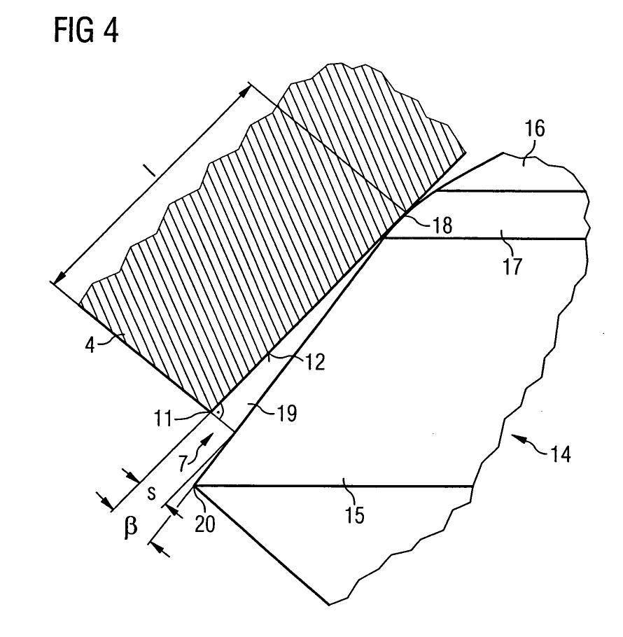

FIG. 2 shows a downstream side region of the valve with an indicated, hollow spherical spray image 10. FIG. 3 and FIG. 4 show enlarged sections of the downstream side region of the valve. The recess 5 in the valve body 4 widens out conically in a downstream side region of the valve body 4 to a separation edge 11, thereby forming an internal cone 12 of the valve body 4. The internal cone 12 of the valve body 4 has a setting angle α which is related to a longitudinal axis 13 of the recess 5.

The valve needle 6 has a closing element 14 on its downstream side end region, said closing element having a first cone 15 and a second cone 16. The setting angle of the first cone 15 is approximately smaller than the setting angle α of the internal cone 12 of the valve body 4 and a setting angle of the second cone 16 is approximately larger than the setting angle α of the internal cone 12 of the valve body. The setting angle of the first cone 15 and of the second cone 16 are likewise related to the longitudinal axis 13 of the recess 5 in a similar manner to the setting angle α.

A sealing band 17 is provided between the first cone 15 and the second cone 16. The closing element 14 locates with the sealing band 17 in a closed position of the valve needle 6 on a valve seat 18, thereby blocking the fuel flow. The valve seat 18 is preferably the center of a contact area of the sealing band 17 of the closing element 14 and of the internal cone 12 of the valve body 4. A mechanical tension is at its greatest in the valve seat 18 by means of a compression of the closing element 14 and of the internal cone 12 of the valve body 4. This mechanical tension is also called Hertzian compression. The sealing band 17 between the first cone 15 and the second cone 16 can be rounded or comprise a further cone, the setting angle of which being preferably somewhat identical to the setting angle α of the internal cone 12 of the valve body 4. Similarly, the first cone 15 and the second cone 16 can directly adjoin one another. This ensures that the valve in the closed position reliably blocks the fuel flow even with manufacturing-specific unavoidable tolerances during the manufacture of the internal cone 12 of the valve body 4, of the first cone 15 or of the second cone 16.

As a result of the different setting angles of the first cone 15 and of the setting angle α of the internal cone 12 of the valve body 4, a gap 19 is embodied downstream of the valve seat 18 between the first cone 15 and the internal cone 12 of the valve body. The gap 19 has a gap angle β, a gap length l and a maximum gap width s. The gap length l is identical to a first distance of the separation edge 11 from the valve seat 18.

The first cone 15 extends downstream of the valve seat 18 to a first edge 20, which has a second distance from the valve seat 18. It has been shown to be advantageous to embody the first distance smaller than the second distance. The spray image 10 then has a particularly favorable form for the combustion.

The gap 19 is embodied such that in the closed position of the valve, the maximum gap width s amounts to a maximum of 10 micrometers. This makes the volume of the gap so small, that only a small amount of fuel can remain in the gap. The fuel is extremely well thermally coupled to the valve body 4 and to the closing element 14, such that the fuel is only minimally heated by means of hot combustion gases and is thus not coked.

The maximum gap width s advantageously amounts to less than 5 micrometers. The volume of the gap 19 is thus particularly small and fuel remaining in the gap 19 is particularly well protected against coking. The maximum gap width s is however embodied to be at least large enough, in the closed position of the valve needle 6, to approximately correspond to a surface roughness of the valve body 4 or of the closing element 14. This ensures that the valve needle 6 with the sealing band 17 seats on the valve seat 18 even with manufacturing-specific unavoidable tolerances during the manufacture of the valve of the closing element 14 in the closed position, and the valve in its closed position reliably blocks the fuel flow.

The maximum gap width s is affected by the gap angle β and the gap length l. The maximum gap width s is determined in the closed position of the valve needle 6 as a path along a straight line, which is perpendicular on the internal cone 12 of the valve body and which touches the separation edge 11, between the separation edge 11 and a point and/or a circular line on the first cone 15. The maximum gap width s can also be determined in a different manner, the previously and subsequently mentioned values for the maximum gap width s, the gap angle β and the gap length l must then be converted accordingly if necessary.

The gap angle β is preferably embodied between 1 degree and 10 degrees, and the gap length 1 between approximately 50 micrometers and 500 micrometers. The maximum gap width s can be determined for example as the tangent of the gap angle β multiplied by the gap length 1. This ratio allows a suitable combination of the gap angle β, the gap length l and the maximum gap width s to be determined. By way of example, the gap length l can be designed to be long, e.g. approximately 280 micrometers, if the gap angle β is designed to be small, e.g. 1 degree approximately. Correspondingly, the gap angle β can be embodied equally as large, e.g. approximately 8 degrees, if the gap length l is embodied to be short, e.g. approximately 50 micrometers. In this case, the manufacturing-specific unavoidable tolerances during the manufacture of the valve are to be accounted for. Furthermore, account must be taken that, in the closed position of the valve needle 6, the maximum gap width s and thus also the volume of the gap can be reduced by means of a Hertzian compression in the valve seat 18 as a function of a force, with which the sealing band 17 in the valve seat 18 is pressed on the internal cone 12 of the valve body 4.

What is claimed is:

1. A valve for injecting fuel comprising:
a valve body in which a recess is embodied, the recess extending into a downstream side region in a flow direction of the fuel in a conical or spherical manner to a separation edge and wherein a wall of the recess in the downstream side region forms a valve seat, and
a valve needle, which is arranged so that it can move axially in the recess, and which has a closing element on a downstream side end region, which widens in the flow direction to a first edge in a conical or spherical shape and in a closed position, the closing element seats on the valve seat and blocks or else releases a fuel flow,
wherein
the separation edge has a first distance to the valve seat,
the closing element being embodied such that a gap is embodied between the valve body and the closing element downstream of the valve seat, said gap having a gap angle and a maximum gap width,
the gap angle and the first distance being embodied such that in the closed position the maximum gap width is at least as large as a surface roughness of the valve body or of the closing element, and
the gap angle and the first distance being designed such that in the closed position, the maximum gap width amounts to a maximum of 10 micrometers.

2. A valve according to claim 1, wherein in the closed position the maximum gap width amounts to a maximum of 5 micrometers.

3. A valve according to claim 1, wherein the first distance amounts to between 50 micrometers and 500 micrometers.

4. A valve according to claim 1, wherein the gap angle amounts to approximately between 1 degree and 10 degrees.

5. A valve according to claim 1, wherein the first edge has a second distance to the valve seat and the first distance is smaller than the second distance.

6. A valve for injecting fuel comprising:
a valve body,
a recess extending into a downstream side region of the valve body in a flow direction of the fuel in a conical or spherical manner to a separation edge,
a valve seat formed by a wall of the recess in the downstream side region, the valve seat having a first distance to the separation edge,
a valve needle, which is arranged so that it can move axially in the recess,
a closing element on a downstream side end region of the valve needle, which widens in the flow direction to a first edge in a conical or spherical shape and in a closed position, wherein a gap with a gap angle and a maximum gap width is embodied between the valve body and the closing element downstream of the valve seat, wherein the gap angle and the first distance being embodied such that in a closed position the maximum gap width is at least as large as a surface roughness of the valve body or of the closing element, and the gap angle and the first distance being designed such that in the closed position, the maximum gap width amounts to a maximum of 10 micrometers.

7. A valve according to claim 6, wherein in the closed position the maximum gap width amounts to a maximum of 5 micrometers.

8. A valve according to claim 6, wherein the first distance amounts to between 50 micrometers and 500 micrometers.

9. A valve according to claim 6, wherein the gap angle amounts to approximately between 1 degree and 10 degrees.

10. A valve according to claim 6, wherein the first edge has a second distance to the valve seat and the first distance is smaller than the second distance.
